(19) United States
(12) Patent Application Publication
(10) Pub. No.: US 2026/0352133 A1
(43) Pub. Date: Nov. 5, 2026

(54) CONTROLLING AN ELECTRIC MACHINE WITH A HARMONIC SUPPRESSION USING A COUNTER SIGNAL IN THE VECTOR SPACE REPRESENTATION

(71) Applicant: SCHAEFFLER TECHNOLOGIES AG & CO. KG, Herzogenaurach (DE)

(72) Inventors: Martin SPORNRAFT, Rottenburg (DE); Thomas BAUMANN, Regensburg (DE)

(73) Assignee: SCHAEFFLER TECHNOLOGIES AG & CO. KG, Herzogenaurach (DE)

(21) Appl. No.: 19/115,480

(22) PCT Filed: Oct. 4, 2023
(86) PCT No.: PCT/EP2023/077445

§ 371 Date: Mar. 26, 2025

(30) Foreign Application Priority Data
Oct. 5, 2022 (DE) 10 2022 210 516.8

(51) Int. Cl. H02P 27/08; H02P 21/22

(52) U.S. Cl. CPC H02P 27/08; H02P 21/22

(57) ABSTRACT

A control device of an electric drive has a basic control loop for vector control having a target value input, a subsequent deviation detection element, a manipulated variable guide element connected downstream of the deviation detection element and a modulation output connected to the inverter for drive purposes and a feedback section. The manipulated variable is used in a space vector representation which relates to a fundamental angular frequency. The inverter control output is connected to an infeed element of a countersignal via a countersignal feedback element. The countersignal feedback element has a countersignal generation element connected downstream of the inverter control output, an inverter control input and/or a supply input of the inverter. At least one power signal is applied thereto in the time domain. The countersignal generation element is configured to calculate and output a space vector representation of the countersignal in relation to the harmonic angular frequency.

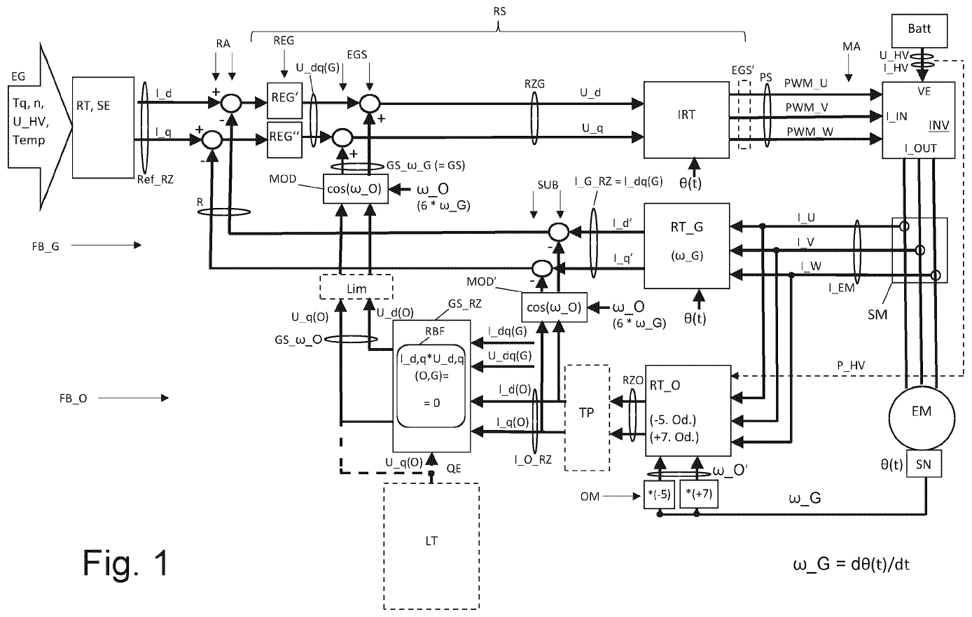

### CROSS REFERENCE TO RELATED APPLICATIONS

This application is the U.S. National Phase Application of PCT International Application No. PCT/EP 2023/077445, filed Oct. 4, 2023, which claims priority to German Patent Application No. 102022210516.8, filed Oct. 5, 2022, the contents of such applications being incorporated by reference herein.

### BACKGROUND OF THE INVENTION

It is known, for example, to provide electric vehicles with an electric drive, wherein an electric machine generates the traction power. In this case, not only is a rotating field at the desired speed (or in the case of asynchronous machines: a rotating field for the desired rotor speed) generated, but also harmonic components are produced by numerous effects. These harmonic components are undesirable and produce losses, noises and similar side effects in the electric machine or in the inverter as well as undesirable AC components in the DC voltage supply of the inverter (“current ripple”).

In order to suppress the harmonic components, it is possible to generate a countersignal which is inverted with respect to the interfering harmonic, such that, when said countersignal is fed in, there is at least partial cancelation. This active suppression (“active canceling”) is based on a countersignal with the right amplitude and, above all, the right phase (compared to the interference signal) in order to be able to cancel it. It has been identified, particularly at variable speeds and thus at variable harmonic frequencies, that there is a considerable computational effort which is to be performed in real time when the countersignal is generated as a time domain signal which is offset by 180° with respect to the time domain signal of the harmonic component.

### SUMMARY OF THE INVENTION

It is therefore an aspect of the invention to show a possibility that enables harmonics to be actively suppressed in a simple manner.

Further properties, features, embodiments and advantages emerge from the dependent claims, the description and the figure.

It is proposed to generate in a basic control loop of an electric machine a countersignal which is not calculated in the time domain, but is reproduced in a space vector representation or is calculated as a space vector representation. The countersignal is also calculated in space vector representation in the countersignal generation element and, in particular, is also fed into the basic control loop in space vector representation. The countersignal generation element is thus configured to use said countersignal in space vector representation or to use space vector representations for the calculation of the countersignal. The calculation therefore uses at least some space vector representations to make the calculation significantly easier. In addition, the countersignal is also output as a space vector representation, with it having also been calculated and created in this way. This enables simplified infeed into the basic control loop in order to at least partially suppress the harmonic components therein by means of the countersignal.

Countersignal generation using a space vector representation can be achieved with significantly less computational effort in real time, wherein, in particular, the matrices or matrix transformations on which the space vector representation is based can be calculated in advance. In contrast to countersignal generation in the time domain, which requires a spectral analysis of the entire signal and a time signal calculation, the procedure illustrated here reduces the effort required for calculation in real time.

A control device for controlling an electric drive is therefore proposed. The electric drive has an inverter and a multiphase electric machine which is connected downstream of the inverter. The control device is used to control the inverter, the electric machine or the drive that comprises the electric machine, and the inverter. The electric machine may be a synchronous machine or an asynchronous machine. The electric machine is, in particular, multiphase. This also applies to the inverter. The number of phases of the inverter preferably corresponds to the number of phases of the electric machine. For example, the electric machine or the inverter may have three or more than three phases, for example six phases.

The control device comprises a basic control loop. This basic control loop is used, in particular, to represent vector control, in particular with a space vector modulation. The basic control loop has a target value input. Target parameters such as target torque and/or target speed can be input at said basic control loop. Secondary condition parameters can also be input at the target value input, for example the current temperature of the electric machine and/or the inverter and/or the magnitude of the DC voltage forming the supply voltage of the inverter (at the supply input thereof).

A deviation detection element is (directly or indirectly) connected downstream of the target value input. This deviation detection element is used to determine the control deviation or to feed in feedback (which carries an actual controlled variable, such as the current flowing through the electric machine). The deviation detection element is used to detect the difference between the target value input and the actual controlled variable and is used to control the electric machine according to the specified torque and/or specified speed. The basic control loop is thus used for the controlled operation of the electric machine in accordance with the inputs at the target value input.

A manipulated variable guide element is connected downstream of the deviation detection element. The manipulated variable guide element has a modulation output (at the end opposite the deviation detection element) which is connected to the inverter for drive purposes. The modulation output of the manipulated variable guide element is configured to output pulse-width-modulated signals for the individual phases of the inverter. These signals are thus output to the controlled system. The modulation output thus outputs control signals for the inverter in the time domain. The manipulated variable guide element preferably has a portion in which manipulated variables are transmitted in space vector representation. The deviation detection element is also configured, in particular, to process target variables and actual controlled variables (which are fed back) in space vector representation and to use same to form a space vector representation of the control difference. This means that the deviation detection element and the manipulated variable guide element are based on space vector representations of manipulated variables or controlled variables that are guided there.

A (space vector) transformation element upstream of the deviation detection element may be provided, which transformation element maps data of the target value input (for example target speed and target torque) into a space vector representation (a reference variable, for instance the target current). Furthermore, it is possible to provided a target variable generation element which converts the data of the target value input into target variables (current), which are transmitted due to the transformation into space vector representation. The target variable generation element and the transformation element may be embodied together as one processing element of the control device or the basic control loop.

The basic control loop has a feedback element or feedback section. Said feedback element or feedback section is connected downstream of the inverter output. Since the inverter output is connected to the electric machine, the feedback section is also connected to the electric machine. Together with the electric machine, the inverter forms the controlled system of the controller. The controlled system receives pulse-width-modulated voltage signals (voltage signals in the time domain) as manipulated variable, wherein the current flowing in the electric machine or in the inverter forms the controlled variable (in time domain representation). The controlled system is thus connected downstream of the manipulated variable guide element.

The feedback section starts from the inverter output or from the electric machine (that is to say from the controlled system). The feedback section carries the power signal or current signal used by the inverter to operate the electric machine, that is to say the signal with which the electric machine (and in particular the inverter) reacts to the controlled variable (such as the pulse-width-modulated voltage or the inverter drive signal). In other words, the feedback section starts from the controlled system. The feedback section also leads to the deviation detection element (addition element for the control error formation, that is to say for the detection of the deviation) and thus forms the feedback of a controlled variable. The controlled variable corresponds, in particular, to the current signal or power signal of the electric machine. The controlled variable is guided to the deviation detection element or to the side of the controlled system which is connected downstream of the target value input (or the subsequent transformation element). The feedback section returns the power signals or activation signals of the inverter output or the electric machine which are present in the time domain (pulse-width-modulated signals) to the deviation detection element. The time domain representation of the controlled variable is transformed into a space vector representation in the feedback section. The feedback section in this case outputs controlled variable signals to the deviation detection element in space vector representation. The feedback section thus includes transformation of the control signal or power signals (controlled variable) of the electric machine in the time domain into a space vector representation of said controlled variables.

The basic control loop is designed for vector control with a manipulated variable in space vector representation. The manipulated variable is, for example, the pulse-width-modulated voltage which is output by the inverter or which corresponds to the pulse-width control signals used to drive the inverter. Said manipulated variable is the variable which is guided by the manipulated variable guide element and is present in a space vector representation.

This space vector representation relates to a fundamental oscillation angular frequency (for short: fundamental angular frequency). The variables in space vector representation, which are present at the deviation detection element, in the manipulated variable guide element and partly in the feedback section, are also presented in a space vector representation which relates to a fundamental angular frequency. The fundamental angular frequency in this case corresponds to the speed of the stator field of the electric machine or (in the case of synchronous machines) the speed of the electric machine. The space vector representations of the basic control loop thus relate to a fundamental angular frequency, which is essentially determined by the speed of the electric machine, and thus also a target speed, which is input at the target value input. The space vector representation can thus have a phasor whose angular frequency corresponds to the fundamental angular frequency.

The control device also has a countersignal feedback element. Like the feedback section of the basic control loop, this starts from the inverter output or from the electric machine (that is to say from the controlled system), in particular from a point in the basic control loop at which the controlled variable is present in the time domain. The inverter control output or the electric machine is connected to an infeed element of a countersignal via the countersignal feedback element. This infeed element can be provided in the manipulated variable guide element of the basic control loop or is provided upstream of an inverter input at which inverter drive signals (generally: the manipulated variable) are present in the time domain. The manipulated variable guide element of the basic control loop may have a manipulated variable portion connected thereto in which the inverter drive signals are present in the time domain, wherein this manipulated variable portion connects the manipulated variable guide element (which at least partially has a space vector representation) to the control input of the inverter. By feeding in the countersignal, which represents an end of the countersignal feedback, it is possible to feed a countersignal into the basic control loop, in particular into the manipulated variable guide element thereof, in order to at least partially compensate for interfering signal components in the basic control loop by way of the countersignal.

The countersignal feedback element has a countersignal generation element. The countersignal generation element is configured to generate a space vector representation of the countersignal or to use the controlled variable in space vector representation when calculating the countersignal. In particular, the countersignal generation element is connected downstream of the controlled system or the electric machine or the inverter control output or the supply input of the inverter, wherein there is at least one power signal (that is to say the controlled variable of the harmonic suppression, for example the current of the electric machine or the AC components of the supply voltage of the inverter) of the drive in time domain representation. In particular, there are signals which represent the power signal. The at least one power signal can therefore be given by: the phase currents of the electric machine, the currents or voltages output by the inverter control output, the supply voltage or the supply current of the inverter (at the supply input of the inverter) or the AC components of the supply voltage or the supply current of the inverter. These power signals (or their reproduction) form the controlled variable of the harmonic suppression or the corresponding control loop.

The at least one power signal (that is to say the controlled variable of the harmonic suppression) relates to the supply signal (current or voltage) of the inverter or to the AC component thereof. In this case, the power signal does not have to be derived directly from the supply input of the inverter, for example by measuring. Instead, the power signal may also relate only to the supply input of the inverter and can be derived from a signal provided at another location in the drive. In particular, the power signal may also relate to the supply input of the inverter and may be derived from the current and/or voltage signals of the inverter control output or the electric machine. A measuring device which detects the current signals and/or voltage signals of the inverter control output or the electric machine may thus be provided. The measuring device may correspond to the phase current measuring device described herein.

A countersignal generation element may make provision for a countersignal to be generated by virtue of the harmonic component (in the power signal at the inverter control output or in the electric machine) being mapped to the countersignal (in space vector representation) on the basis of a reduction condition. A harmonic component in this case refers to a signal which reflects the harmonic itself or is a variable characterizing the harmonic, either partially, for example only the current component, only the harmonic within the controlled variable, only the voltage component, only the harmonic within the controlled variable, only the power or only the amplitude, or as a result of a preliminary calculation for combination with another variable, or completely, for example as amplitude or power including the phase information or as a time profile signal of current and voltage (or of the manipulated variable and controlled variable) in vector representation or as a representation in the time domain.

The reduction condition may make provision for the harmonic component in the power signal to be reduced at the supply input of the inverter. Starting from the power signal present at one location in the drive, for example at the inverter control output or in the electric machine, the reduction condition is used to generate a countersignal which is designed to at least partially reduce the harmonic component at another location in the drive, for example at the supply input of the inverter. The input variable of the reduction condition can therefore relate to the inverter control output or to the electric machine, while the output variable relates to the supply input of the inverter. The mapping by means of the reduction condition can thus involve conversion of the harmonic component at the inverter control output or in the electric machine to a resulting harmonic component at the supply input of the inverter.

The reduction condition can thus take into account the fact that the countersignal is generated to reduce the harmonic component at the supply input of the inverter, while the input variables of the reduction condition are power signals of the inverter control output or the electric machine. An example of the reduction condition makes provision for a reduction in the power of the harmonic component at the supply input of the inverter. This may be represented by the condition that the result (power) of the convolution of the components of the space vector representation of the voltage signals at the control input of the inverter (in the Figure: reference signs U_d, U_q) with the components of the space vector representation of the current signals at the inverter control output or in the electric machine (in the Figure: reference signs I_d', I_q') is equal to zero.

The condition can be represented in simplified fashion by:

P_VE=I_d′(ω_O)*U_d(ω_G)+I_d′(ω_G)*U_d(ω_O)+L_q′(ω_O)*U_q(ω_G)+L_q′(ω_G)* U_q(ω_O)

where:
P_VE: power of the harmonic component at the supply input of the inverter
I_d′: first component of the space vector representation of the current I
Lq′: second component of the space vector representation of the current I
U_d: first component of the space vector representation of the voltage U
U_q: second component of the space vector representation of voltage U wherein the current I indicates the current at the inverter control output or in the electric machine, the voltage U indicates the voltage at the inverter control output or in the electric machine, the suffix (ω_O) to a variable indicates that the space vector representation of the variable relates to the harmonic angular frequency, the suffix (ω_G) to a variable indicates that the space vector representation of the variable relates to the fundamental angular frequency, and the reference sign of the variable corresponds to the reference signs in the Figure. The variables P_VE, I_d′, I_q′, U_d′ and/or U_q′ may also be standardized variables, for example normalized to a total power, a nominal current, an operating current (RMS value), a nominal voltage or an operating voltage. The character ‘*’ may represent a convolution if the spectral ranges of the relevant variables are to be taken into account or it may represent a multiplication if the relevant variables are scalars, for example scalars of a space vector representation.

In simplified terms, the condition can thus be represented by the sum of all products consisting of a space vector component of the current and a space vector component of the voltage, where the two factors of each product relate to space vector representations of different angular frequency (fundamental angular frequency or harmonic angular frequency). Current and voltage relate in this case to the inverter control output or the electric machine

The power signal in question can reflect the harmonic components present in the drive signal (current or voltage, multiphase) of the inverter or the phase currents in the electric machine. The harmonic components in the drive signal of the inverter or in the phase currents of the electric machine are linked to harmonic components in the (DC voltage) supply signal at the supply input of the inverter due to the reaction of the drive signal to the supply input of the inverter. The control objective may therefore be the at least partial compensation of the harmonic components in the drive signal of the inverter/in the phase currents of the electric machine, or the at least partial compensation of the harmonic components in the supply signal (current, voltage) of the inverter. The power signal can thus also reproduce the harmonic components present in the supply signal (current or voltage) of the inverter. In particular, the supply signal is a power signal. The supply signal of the inverter preferably corresponds to the power signal output by a battery to the drive or to the inverter.

A transformation may be provided to convert these signals from the time domain to a space vector representation. This space vector representation can then be mapped to the countersignal (also in space vector representation) by means of a countersignal calculation element of the countersignal generation element. Since both variables are present in space vector representation, the mapping is associated with little computational effort, especially since elements of this mapping, such as transformation matrices, can be calculated in advance, such that only little computational effort arises during operation. The countersignal is inverted with respect to a harmonic component in the power signal so that, when combined appropriately, the harmonic components (be it in time domain representation or in space vector representation) in the basic control loop or in the manipulated variable guide element or at the inverter (inverter control output, supply input of the inverter) can be at least partially canceled. The inventive calculation or output of the countersignal by the countersignal generation element in space vector representation significantly reduces the computational effort, especially during running operation (real time) compared to time domain-based calculations. In addition, numerous space vector representations are already known and can be realized by easily available circuits.

The infeed element (of the countersignal) is connected downstream of the countersignal generation element. This infeed element can be provided in a portion of the manipulated variable guide element of the basic control loop in which the manipulated variable is guided or transmitted in space vector representation. In other words, the infeed element can be provided where the signals are transmitted and processed in the manipulated variable guide element in space vector representation.

The infeed element is preferably configured to combine the space vector representation of the countersignal with the space vector representation of the manipulated variable. The combination results in an at least partial cancelation of the harmonic component. The resulting combined space vector representation is transmitted in the manipulated variable guide element as manipulated variable. In other words, the infeed element injects the countersignal into the manipulated variable guide element in space vector representation, wherein the manipulated variable guide element operates at this point in space vector representation. This results in a reduction of the harmonic component by the countersignal. The countersignal is thus subtracted from the harmonic component, both of which are represented in space vector representation during the subtraction. In particular, in the countersignal infeed element, both are present in a space vector representation, which rotates at the fundamental angular frequency like the basic rotating system of the manipulated variable or the controlled variable so that the harmonic components and the countersignal are modulated at the harmonic angular frequency. In such a representation of the combination of harmonic component and countersignal, which leads to the canceling interference between harmonic component and countersignal, the harmonic component occurs at the harmonic angular frequency in the space vector representation which is based on the fundamental angular frequency. The countersignal is adapted to this frequency and is provided in a space vector representation based on the fundamental angular frequency and in which the countersignal is provided at the harmonic angular frequency.

Before this combination of the countersignal with the manipulated variable (that is to say before the countersignal infeed), the countersignal (in particular for its calculation) can be provided in a space vector representation which rotates at the harmonic angular frequency. This then results in quasi-static parameters for the representation of the countersignal, which can be calculated particularly easily.

If the space vector representation is based on the fundamental angular frequency, the space vector representation can be related to the rotation of the rotor and can be static in relation to the rotor. However, the countersignal and the harmonic component rotate with respect to the rotor at a multiple, especially in the case of the countersignal infeed element. If the countersignal or the harmonic component affects n times the fundamental frequency, then the countersignal and also the harmonic component are present as a harmonic angular frequency, which corresponds to n times the fundamental angular frequency. To this end, the countersignal can be modulated at the desired n-fold, that it to say with a cosine or sine signal whose frequency corresponds to the harmonic angular frequency.

The countersignal infeed element (for short: infeed element) may also be provided in a manipulated variable guide element or in a manipulated variable portion which is contained in the basic control loop and in which the manipulated variable is transferred or guided as a pulse-width-modulated time domain signal. In other words, the infeed element can be provided at a location in the basic control loop (between the target value input and the inverter control input) at which signals (in particular the manipulated variable) are processed and transmitted in the time domain. For example, the infeed element can be provided at the control input of the inverter or at the modulation output of the manipulated variable guide element in order to feed in the countersignal in the time domain there. In this variant, the infeed element is configured to combine a time domain representation of the countersignal with the pulse-width-modulated time domain signal. This reduces the harmonic component present in the time domain signal by the countersignal, which is also present in the time domain. The combined signal obtained in this way, the harmonic component of which is reduced by the countersignal, is transmitted in the controlled system as a manipulated variable. The infeed element can be configured to combine the countersignal in time domain representation with a pulse-width-modulated time domain signal which represents the manipulated variable.

The countersignal in time domain representation can also be fed with another time domain signal into the section between the target value input and the inverter. In this variant, provision is made for the infeed to be carried out in the time domain and also for the resulting signal to be transmitted as a time domain signal. In particular, the countersignal is received at the infeed element in time domain representation and combined with the signal which is transmitted in the section between the target value input and the inverter in time domain form.

An infeed and combination of the countersignal in space vector representation has the advantage that the countersignal present in space vector representation does not have to be transformed. Although an infeed in the time domain requires transformation of the space vector representation of the countersignal into a time domain representation, this transformation does not require a particularly high computational effort. In particular, calculations can also be carried out in advance during this transformation, for example preliminary calculations of a transformation matrix, such that only a limited computational effort is required during operation in real time.

In the case of infeed as a time-domain signal, the countersignal is combined as a signal which is modulated at the harmonic angular frequency. The harmonic component to be reduced and the countersignal thus have the same frequency, namely the frequency which corresponds to the harmonic angular frequency, such that, at a suitable phase position, the harmonic components can be at least partly canceled.

One aspect is that a modulator is connected between the countersignal generation element and the infeed element. This modulator is configured to modulate the space vector representation of the countersignal calculated by the countersignal generation element at the harmonic angular frequency. As an alternative, the modulator is configured to modulate the time domain representation of the countersignal calculated by the countersignal generation element at the harmonic angular frequency. This results in a modulated space vector representation or time domain representation of the countersignal, which is output to the infeed element. If the countersignal generation element generates the countersignal in a form already modulated at the harmonic angular frequency, then the modulator is obsolete and the already modulated signal can be output to the infeed element.

The countersignal generation element preferably has a harmonic detection element. Said harmonic detection element has an input which is connected to the inverter control output or to the electric machine (in a signal-transmitting manner) or which is connected to a supply input of the inverter (in a signal-transmitting manner). There, the controlled variable, that is to say the at least one power signal, is present in the time domain. The power signal used here is the drive signal of the electric machine or the inverter (current and/or voltage) or the inverter control output or the supply signal of the inverter (current and/or voltage). These signals contain the harmonic component to be compensated, such that at least the AC component thereof represents the controlled variable. In particular, the harmonic component is extracted from the signals to form the controlled variable. The harmonic detection element is configured to detect the harmonic component (signal strength, phase position) in the power signals.

The harmonic detection element has, in particular, an input which is connected to the controlled variable guide element and/or to the feedback section. The harmonic detection element is configured to determine the harmonic component from the manipulated variable and/or the controlled variable present at the controlled variable guide element or feedback path or to take same into account in the countersignal generation or to carry out the countersignal generation according to the harmonic component. For this purpose, it is possible to use mapping, in particular empirical mappings, or harmonic calculations which consider all or only some (or also only one) harmonic frequency and which at least approximately calculate the harmonic component from the manipulated and/or controlled variable, in particular the harmonic component which is produced by the respective variable(s) in a supply signal (supply current, supply voltage) of the inverter. For this purpose, the relevant variables are preferably present in space vector representation or are taken in this form from the manipulated variable guide element or the feedback section. In particular, the manipulated variable is preferably taken from the manipulated variable guide element upstream of the location where the countersignal is fed in (and in particular downstream of the deviation detection element). The manipulated variable and/or the controlled variable are preferably present in a space vector representation, which relates to a (rotation at the) fundamental angular frequency. To determine the harmonic component, the manipulated variable and/or the controlled variable can be present in a space vector representation based on the fundamental angular frequency and additionally in a space vector representation which relates to the harmonic angular frequency. The harmonic component can be determined as an approximation, in particular as an approximation only for a frequency, in particular the frequency corresponding to the harmonic angular frequency.

For example, when using two-vector space vector representations (such as a d/q representation), the harmonic component can be determined by using a sum of products of two factors, the first factor being one of the two vectors corresponding to the manipulated variable and the second factor being one of the two vectors corresponding to the controlled variable, where one of the two factors is a vector in a space vector representation at harmonic angular frequency and the other factor is a vector in a space vector representation at fundamental angular frequency. The result is a term which represents the compensated harmonic component and which can be set to zero in order to determine the vectors of the manipulated variable in space vector representation at harmonic angular frequency which form the countersignal or define the phase and amplitude thereof (in space vector representation). For example, the term shown herein for P_VE can be used to represent the harmonic component within the reduction condition, wherein, in this case, the harmonic component is obtained by the two vectors of the manipulated variable in space vector representation at the fundamental angular frequency and by the vectors of the controlled variable in space vector representation at the fundamental angular frequency and in space vector representation at the harmonic angular frequency. The two vectors of the manipulated variable in space vector representation at the harmonic angular frequency in this term correspond to the countersignal (in space vector representation).

The harmonic detection element also has an output which is configured to output the detected harmonic component, wherein the harmonic component is output in space vector representation (harmonic space vector representation). The harmonic component may be output as a parameter which reflects the strength of the harmonics, in particular the strength of a concomitantly rotating and a counter-rotating system rotating at harmonic angular frequency. The rotation relates to the rotation relative to the rotor or to the space vector representation of the basic control loop. This parameter information is preferably combined with the phase position. During calculation, it must be taken into account that the harmonic space vector representation refers to either the rotor or the stator, wherein differences arise when the fundamental space vector representation of the relevant manipulated variable is stator-fixed or already rotates with the rotor and is thus rotor-fixed. The harmonic space vector representation generated by the countersignal generation element can be used by the countersignal generation element directly to generate the countersignal, which is also present in the space vector representation. The calculation of the countersignal within the countersignal generation element is also preferably a space vector-based representation.

The harmonic detection element may be configured in different variants. The harmonic detection element may be in the form of a harmonic space vector representation. This transforms the power signals (controlled variable signals in time domain representation) into a space vector representation. This space vector representation can rotate at the harmonic angular frequency relative to the space vector representation of the manipulated variable. Depending on the type of transformation, the harmonic angular frequency can also rotate relative to the stator, wherein, in this case, the representation of the manipulated variable must be taken into account and, in particular, it must be taken into account whether this relates to the stator or to the rotor, that is say whether it is stator-fixed or rotor-fixed.

The harmonic detection element may also be in the form of a high-pass filter or bandpass filter. This filter is configured to block the fundamental angular frequency and to allow the harmonic angular frequency to pass through. The filter is designed, in particular, to attenuate the fundamental angular frequency by at least five, ten, 20 or 30 decibels more than the harmonic angular frequency or as frequencies which are more than a factor of 2 or its reciprocal value or more than a factor of 4 or its reciprocal value of the harmonic angular frequency.

Finally, the harmonic detection element may also be in the form of a spectral analysis device which, for example, implements a Fourier transformation. The spectral analysis device is designed to extract, as a spectrum, components of the harmonic angular frequency, in particular together with the phase of these components.

If the harmonic detection element is designed as a harmonic space vector transformation element, the harmonic components are mapped by the transformation element based on the harmonic angular frequency (while the fundamental components are not mapped). In addition to the space vectors, the phase position is also detected and output during this transformation. In a configuration as a high-pass filter or bandpass filter, the relevant signals are also output in the form of a signal strength or amplitude of the harmonic component, together with the relevant phase position. The phase position relates, in particular, to the power signals or the controlled variable.

The countersignal generation element preferably comprises a countersignal calculation element. The countersignal calculation element is connected downstream of the harmonic detection element. While the harmonic detection element detects the strength and angle (phase position relative to signal components at fundamental angular velocity) of the harmonic signal, the countersignal generation element generates a signal from this which is suitable for reducing the detected harmonic component in the power signal (at the inverter control output or at the supply input of the inverter). The countersignal generated by the countersignal generation element is inverted to the harmonic signal detected by the harmonic detection element, that is to say, for example, shifted by 180 degrees in order to at least partially cancel and thus reduce the harmonic signal. The countersignal is suitable for reducing the harmonic component in the power signal (that is to say current or voltage at the inverter control output or in the electric machine or current or voltage in the inverter supply signal). In this case, the countersignal may be configured according to the provision (reduction condition) to reduce the harmonic component in the power signal of the supply input of the inverter or to reduce the harmonic component in the power signal of the inverter control output or the electric machine. The countersignal is preferably configured according to the provision to reduce the harmonic component in the power signal of the supply input of the inverter in order to thus reduce a ripple current which loads a DC link capacitor at the supply input of the inverter. The provision can therefore provide for at least partially compensating for the alternating current load on the DC link capacitor at the supply input of the inverter.

The harmonic detection element, together with the reduction condition, can represent a measure for the harmonic component (in order to generate the countersignal according to this harmonic component). The harmonic detection element in this case processes the controlled variable of the basic control loop (see the Figure: controlled variable I_U-I_W, that is to say the controlled variable as a time signal or preferably its space vector representation I_d′, I_q), while, in the reduction condition, the result of the harmonic detection together with the manipulated variable of the manipulated variable guide element (see the Figure: manipulated variable U_dq(G), that is to say preferably before the infeed of the countersignal, that is to say the manipulated variable without the countersignal) is used to generate the countersignal according to the reduction condition. In other words, the harmonic component is obtained when processing the signal which outputs the harmonic detection, together with the manipulated variable when the reduction condition is applied. It can therefore be provided that the harmonic component output by the harmonic detection element is combined with the manipulated variable (within the reduction condition or the countersignal generation) in order to form a measure of the harmonic component which is the basis for the countersignal generation (within the reduction condition).

The countersignal calculation element has an input which is configured to receive the harmonic component. The harmonic component is represented in space vector representation here. The input is configured to receive both the strength of the harmonic component and the phase position of the harmonic component (as opposed to the power signal component at the fundamental angular frequency). The countersignal calculation element is configured to map the space vector representation of the harmonic component to the space vector representation of the countersignal using a reduction condition. The countersignal calculation element thus has a reduction condition which may be, for example, that the sum of the countersignal and the detected harmonic component results in 0 (or no more than a predetermined magnitude), or that the sum of the countersignal and the harmonic component detected at the inverter output leads to an harmonic component at the supply input of the inverter of 0, or that the (calculated or detected) power of the harmonic component at the supply input of the inverter, such as the power P_VE as shown above, results in 0.

The countersignal calculation element can provide an approximation which, as input variables, represents a controlled variable of the basic control loop (for example the phase current or its fundamental component, cf. reference sign I_dq(G) in the Figure), a variable of the controlled system (for example the voltage input to the inverter control input, cf. reference sign U_dq(G) in the Figure) and has the harmonic component (cf. reference sign L_d(0), I_d(O), in the Figure) preferably in each case in space vector representation. The latter may together be part of the reduction condition. The reduction condition may provide that the result of the approximation is 0, wherein the approximation represents the harmonic component (approximated) present in a power signal (supply signal of the inverter, phase current, etc.).

The countersignal calculation element may have, as input variable, in particular, a controlled variable which is fed from the inverter control output of the inverter into the feedback section. The input variable(s) is/are preferably received in space vector representation. Provision is made to calculate the harmonic component, in particular in combination with the controlled variable.

The reduction condition is provided, in particular, in space vector representation. The countersignal can be calculated from the reduction condition in a simple way using the harmonic component. The reduction condition may also provide that the strength of the countersignal corresponds to the strength of the harmonic component, while the phase position is offset by 180° relative to one another. Another option is to provide different signs for the countersignal and the harmonic component at an angular offset of 0 between the countersignal and the harmonic component. For example, the countersignal can be generated by multiplying the harmonic component by minus 1 (with the same phase position). The reduction condition reflects the fact that the countersignal component and harmonic component (at the inverter output or at the supply input of the inverter) are at least partially canceled or that the harmonic component is suppressed or attenuated by the countersignal. In particular, the reduction condition reflects the fact that an approximated harmonic component, such as the component P_VE, as is illustrated as power previously, is minimized or (as target) equal to zero.

The harmonic component is mapped to the countersignal, taking into account an angular relationship between the manipulated variable in the controlled system and the controlled variable (for example the power signals of the electric machine or the signals at the inverter control output). In this case, both the power signals (that is to say the controlled variable) and the manipulated variable are preferably present in a space vector representation. The manipulated variable may instead be provided in space vector representation while the power signals are represented in time domain, wherein the angular relationship can be determined, for example, by transferring the power signals into a space vector representation and by detecting the angular relationship of this space vector representation and the space vector representation of the manipulated variable. The power signals correspond to the controlled variable present at the inverter control output or the controlled variable used to operate the electric machine.

The space vector representation used here is preferably reproduced with values which are reproduced on two mutually angularly fixed axes. These axes rotate at the associated angular frequency. This applies, in particular, to the representation of the countersignal or another signal which is shown in space vector representation as mentioned here. The space vector representation of variables in the manipulated variable guide element relates to vectors which rotate at the fundamental angular frequency. The space vector representation of countersignal generation or harmonic detection variables, or the countersignal calculation, relate to two mutually angularly fixed axes and rotate at the harmonic angular frequency. The infeed element preferably uses a space vector representation which rotates at the fundamental angular frequency, which is why the countersignal is fed in there as a signal which is modulated at the harmonic angular frequency in order to reproduce its faster rotation (in comparison to the fundamental angular frequency).

The space vector representation provides, in particular, two mutually angularly fixed rotating axes which are perpendicular to one another. The space vector representation then relates to a complex representation, where the two axes correspond to the real and the imaginary components of the complex representation.

The space vector representation of the countersignal is thus preferably reproduced by two mutually angularly fixed rotating axes which, in particular, form an angle of 90°. The space vector representation of the countersignal can thus be particularly complex with a real and imaginary axis offset by 90° therefrom. The countersignal calculation element provides a reduction condition which can be met by only one of the axes of the space vector representation. This results in an underdetermined system. Thus one axis of the space vector representation can be subjected to the countersignal calculation, while the other axis can be selected essentially freely. However, the height of the other axis plays a role in calculating the axis according to the reduction condition. In the calculation of the axis which is calculated according to the reduction condition, the value of the other axis therefore serves as an input in order to generate by means of the reduction condition a countersignal which at least partially suppresses the harmonic component. It may therefore be provided that the countersignal calculation element is configured to map a value of one of the axes from the countersignal calculation according to the reduction condition, while a value source specifies the associated value of the other axes. For example, said value source may be a look-up table or it may also be a constant value.

The countersignal calculation element has an input which is connected downstream of the value source. The value source is thus connected to the input for drive purposes and/or to the input for the purpose of outputting the signal. The countersignal calculation element is preferably configured to map the space vector representation of the harmonic component to the space vector representation of the countersignal taking into account the associated value. In other words, values of the first-mentioned axis are mapped to different values by means of the reduction condition for different values present at the input of the countersignal calculation element (and supplied by the value source).

The feedback section of the basic control loop preferably has a subtraction element. Said subtraction element is configured to subtract the harmonic component from a controlled variable transmitted by the feedback section, where the resulting signal (that is to say the difference) is transmitted from the subtraction element within the feedback section. In this way, the influence of the harmonic component is suppressed within the feedback section, such that the basic control loop does not change the manipulated variable due to the harmonic components. Instead of subtracting the harmonic component from the controlled variable, provision may also be made for the subtraction element to subtract the countersignal from the controlled variable.

The subtraction element operates in a space vector representation; therefore, the subtraction is performed using variables present in space vector representation. The subtraction element is entered with the (fed back) controlled variable in space vector representation. The harmonic component or the countersignal are also output to the subtraction element in a space vector representation. In this case, the subtraction element receives the controlled variable in a space vector representation based on rotation at the fundamental angular frequency. Since the space vector representation of the harmonic component or the countersignal for subtracting from the controlled variable should also relate to the fundamental angular frequency, the harmonic component or countersignal is output to the subtraction element in a form modulated at the harmonic angular frequency. The subtraction element thus receives the harmonic component or the countersignal in space vector representation, based on the fundamental angular frequency, but in a form modulated at the harmonic angular frequency, in order to take account of the fact that the feedback section transmits the controlled variable as a space vector representation based on the fundamental angular frequency and that the harmonic component has a higher frequency in comparison thereto, namely the harmonic angular frequency. If the countersignal is fed in instead of the harmonic component, then, instead of the fundamental source signal, a version of it rotated by 180 degrees or a version of it multiplied by minus 1 is output to the subtraction element.

The subtraction element is provided in a portion of the feedback section of the basic control loop in which signals are transmitted in space vector representation. The space vector representation relates here to the fundamental angular frequency. The harmonic component is also subtracted in space vector representation in the subtraction element, wherein said space vector representation is based on the harmonic angular frequency. In other words, the harmonic component which is subtracted in the subtraction element is provided in space vector representation, which rotates at the fundamental angular frequency (for the correct subtraction of the signals mentioned at the outset), but in a form modulated at the harmonic angular frequency or with the ratio of harmonic angular frequency to fundamental angular frequency. The latter serves to subtract a space vector representation, to rotate the coordinate system thereof at the same angular frequency (the fundamental angular frequency), while at the same time taking into account the fact that the harmonic component rotates faster compared to the signal in the basic control loop in space vector representation, namely at the harmonic angular frequency. The latter is achieved by modulation at the harmonic angular frequency (or a ratio of the harmonic angular frequency to the fundamental angular frequency).

The countersignal generation element may have a countersignal calculation element, as described above. The countersignal calculation element preferably has an input which is configured for receiving a controlled variable provided in space vector representation and output by the inverter control output. The input can thus be provided for receiving a controlled variable in space vector representation, wherein the controlled variable corresponds to the power signal which is output by the inverter or which is used to operate the electric machine. Provision may also be made for the input to be configured for receiving a manipulated variable of the controlled system, which is reproduced in space vector representation. The space vector representation of the controlled variable and the manipulated variable both relate to the fundamental angular frequency. The countersignal calculation element can thus determine the phase position of the controlled variable and the manipulated variable. In particular, the phase position of the countersignal to the controlled variable or to the manipulated variable can be provided in such a way that the countersignal at least partially suppresses the harmonic component.

Further embodiments make provision for a two-part linear controller to be provided between the deviation detection element and the subsequent infeed element of the countersignal. The controller has, in particular, a first and a second controller part. The first controller part relates to a first axis of the space vector representation and the second controller part relates to a second axis of the space vector representation. In particular, the first controller part can relate to a real axis and the second controller part can relate to an imaginary axis of the space vector representation of the signal which is transmitted in the controlled system. The controller parts therefore also work with signals which are displayed in the space vector representation. This simplifies the control. The controller parts are each preferably linear controllers, such as PID controllers. The controller parts are preferably not intertwined with one another and control individually. The controller parts are each in particular continuous-action controllers.

A limiter can be connected downstream of the countersignal generation element or the countersignal calculation element. Said limiter can reduce the amplitudes of the space vector representation of the countersignal. The limiter is preferably connected upstream of the modulator via which the limited signal is output to the infeed element of the countersignal. As an alternative, the limiter is connected downstream of the modulator in order to provide amplitude limitation for the modulated countersignal (in space vector representation). The limiter also works with signals which are provided in space vector representation, in particular in a space vector representation which relates to a rotation at the fundamental angular frequency.

A sensor, in particular an angle sensor, may be arranged on the electric machine or, as an alternative, a unit which determines the current rotor angle of the electric machine, for example from the power signals (current and/or voltage signals) which are used to operate the electric machine. The angle signal output by the sensor can be output to an input of the harmonic detection element. The harmonic detection element is configured to relate the power signal of the electric machine or the power signal output by the inverter to the angle signal in order to output a space vector representation of the harmonic component together with the correct angle. The angle signal is adapted to the variables with which the harmonic detection element works, wherein the harmonic detection element receives a modulated signal. Provision may therefore be made of at least one harmonic modulator which modulates the angle signal in order to thus adapt it to the rotation of the space vector representation of the harmonic detection element. In particular, two harmonic modulators may be provided to modulate the angle signal on the one hand at a frequency corresponding to the harmonic angular velocity plus 1 (corresponding to the rotation of the basic system or the rotor) or plus 2π (corresponding to the rotation of the basic system or the rotor in angular velocity representation) in order to thus generate a concomitantly rotating harmonic system. The other modulator may be configured to multiply the angle signal by the difference between 1 (single speed according to the basic angular velocity) or 2π (single basic angular velocity) minus the harmonic angular velocity in order to produce a counter-rotating harmonic system. These modulation factors take into account the fact that the space vector representation of the basic control loop already rotates at the basic angular velocity and is therefore not stator-fixed, but rotor-fixed, and that the harmonic component rotates with respect to the fundamental component and thus with respect to the rotor and not with respect to the stator. In other words, the angle signal is modulated to produce a concomitantly rotating and a counter-rotating harmonic system which rotates at the harmonic angular frequency relative to the rotor-fixed basic system, or in the ratio of the harmonic angular frequency to the fundamental angular frequency, and that the rotation at the fundamental angular frequency already means a simple rotation (with 1 and 2π respectively), while the harmonic systems are mounted on the already rotating basic system.

A transformation element can be provided in the controlled variable guide element of the basic control loop or upstream of the inverter control input which transforms the manipulated variables provided in space vector representation into corresponding signals in the time domain. The resulting signals, in particular the pulse-width-modulated time signals, are input into the inverter for actuation at the actuation input (inverter control input) thereof. This transformation may also be referred to as inverse space vector transformation, IRT.

The target value input may have a transformation or mapping element connected downstream which converts the input values into variables in space vector representation, in particular into input controlled variables. This transformation can be referred to as a space vector transformation and can also include conversion of the target variables (speed, torque) into target currents (in space vector representation or as parameters thereof). Between said space vector transformation and the inverse space vector transformation within the manipulated variable guide element, the variables provided there, in particular the manipulated variables provided there, are transmitted and processed in space vector representation. The manipulated variables may relate to the voltage, wherein target voltage values are input (in a pulse-width-modulated form) into the control input of the inverter.

The current can be provided as a controlled variable, in particular as a variable within the feedback element of the basic control loop. This current corresponds to the current flowing in multiple phases in the electric machine or corresponds to the current which is used by the inverter to operate the electric machine. These variables can be measured, in particular, at the output of the inverter, in the feed to the electric machine or at the electric machine. The current is detected in time domain representation and, in particular, in multiphase mode, in particular by measuring. The feedback element of the basic control loop also has a transformation element which converts said controlled variable (in time domain representation) into a space vector representation. This can also be referred to as a space vector transformation, in particular as a space vector representation of the controlled variable which is fed back.

The space vector representations mentioned here, in particular the d, q representations, result from, for example, a Park transformation. In addition, the space vector representation may be a representation of the positive phase-sequence system and negative phase-sequence system of symmetrical components, which result, for example, from a Fortescue transformation. The space vector representation is preferably a rotor-related space vector representation. As an alternative, space vector representations which relate to the stator can be used, such as space vector representations resulting from a Clarke transformation. Thus, the space vector representation may also be a α, β representation.

The Figure is used to explain the control device described here and the control method implemented thereby using exemplary embodiments in symbolic representation.

The Figure shows a control device having a basic control loop which has a target value input EG, a subsequent deviation detection element RA, a manipulated variable guide element RS and a modulation output MA, to which an inverter INV (or the control input I_IN thereof) is connected. The inverter INV is actuated by the end of the manipulated variable guide element RS using actuation signals PWM_U, PWM_V, PWM_W in the time domain, that is to say by means of a multiphase pulse-width signal PS. The inverter INV receives a pulse-width modulation signal PWM_U to PWM_W for each phase U, V, W at an inverter control input I_IN. Said signal is a voltage signal and is used for pulse-width-modulated voltage control of the inverter.

The inverter has an inverter control output I_OUT which is also multiphase and which is connected to the electric machine EM in multiphase mode. The electric machine EM itself also has several phases and thus also several phase connections, resulting in a multiphase connection between the electric machine and the inverter INV.

The basic control loop also has a feedback section which couples the inverter control output I_OUT or the electric machine EM (that is to say the connection between the inverter INV and the electric machine EM) back to the deviation detection element RA, which determines a control deviation. This enables the deviation detection element RA to determine the error (=control deviation) between the target variable and the actual variable and to accordingly feed in readjusted values which are corrected by the control deviation in the manipulated variable guide element RS.

The feedback section FB_G of the basic control loop thus provides a feedback element R, via which the target variable is fed back in order to determine the control error at the deviation detection element RA which is used for control. The feedback section transmits the controlled variable (present in space vector representation) in the form of the current which is used to operate the electric machine EM to the deviation detection element RA. There, said fed-back controlled variable (actual current of the electric machine) is compared with the corresponding target variable (present in the space vector representation), namely with the current which is also output to the deviation detection element RA. The deviation detection element RA is followed by a two-part controller REG which outputs the manipulated variable corresponding to the difference in the form of the voltage U_D, U_Q to the further manipulated variable guide element RS.

The basic control loop is configured for vector control. Numerous portions or sections (including the manipulated variable guide element or portions thereof) of the control device use variables in space vector representation, with this generally being represented by the suffix RZ in the reference signs, and specifically for individual variables with the suffix “_d”, “_q” as d and q components in the relevant variable in space vector representation. The input variables of the target value input EG are converted by a target variable generation element SE which generates the target variable in the form of the current from said input data. The target current is represented in space vector representation here by the d and q components I_d and I_q. These form the (multi-part, two-dimensional) target variable generated from the input variables EG by the target variable generation element SE, which further comprises a space vector transformation RT in order to provide the target variable in space vector representation. This target variable is transmitted to the deviation detection element RA (in space vector representation).

The deviation detection element RA, which calculates the control deviation, also works with target and actual variables in space vector representation. The controller REG consisting of the two parts REG′ and REG″ also works with the control difference (in space vector representation) and generates therefrom a manipulated variable U_d, U_q, that is to say a (complex) voltage in space vector representation. The voltages U_d and U_q of the manipulated variable guide element RS correspond to (interference-suppressed) space vector variables. The manipulated variable guide element RS ends with an inverse space vector transformation IRT, which generates a time signal (PWM_U-PWM_W) or a pulse-width-modulated signal PS from the space vector variables RZG of the voltages U_d and U_q of the manipulated variable guide element RS.

The corresponding space vector representation I_G_RZ of the current is generated from the resulting controlled variable I_EM, that is to say the current flowing in the electric machine EM in time domain representation by the space vector transformation RT_G, wherein this is also represented by the components I_d′ and I_q'. The feedback section FB_G therefore also has the controlled variable in the form of a space vector representation. This is returned by the feedback element R (in space vector representation) to the deviation detection element RA, which also works in space vector representation and calculates the control deviation in space vector representation. The deviation detection element RA is used to determine the control deviation, which is why the control deviation can be assigned to the same reference sign when considering the signal.

In summary, both the manipulated variable guide element RS and the controlled variable feedback element FB_G have components and portions in which manipulated variable signals and controlled variable signals are transmitted and processed in space vector representation. These space vector representations RZ within the basic control loop relate to the fundamental angular frequency, which is essentially determined by the speed n (of the rotor or stator rotation field). The speed n is the target speed and part of the input variables EG. In addition to the speed n, the target torque Tq is also input as the input variable, if necessary in addition to the variables U_HV, that is to say the current supply voltage of the battery Batt which feeds the inverter INV, and/or at least one temperature parameter TEMP which represents the temperature of the electric machine EM, the inverter INV, the battery Batt or a combination thereof.

To understand the procedure shown here, it is important to take into account the fact that, in many locations in the basic control loop, variables are transmitted and processed in space vector representation and that this space vector representation relates to a rotating system. In particular, this relates to the rotating stator system or to the rotating rotor. In the illustrated embodiment, the space vector representation is rotor-fixed, that is to say represents a system or coordinate axes which are provided fixedly on the rotor (or are fixedly linked to the rotating system generated by the stator) and thus require a rotation at a certain angular frequency. For the components and portions shown above, this is the fundamental angular frequency ω_G. As an example, it is shown that the electric machine EM can have an angle sensor SN which measures the current rotation angle θ(t). The time derivative dθ(t)/dt corresponds to the angular frequency ω_G which represents the movement of the rotor (or the rotation of the magnetic field system generated by the stator).

In order to actively reduce or suppress harmonic components within the variables of the basic control loop, the invention provides a countersignal calculation element by means of which a countersignal GS can be generated. The countersignal is combined with a variable of the basic control loop and thus actively cancels at least part of the harmonic component. In order to simplify the calculation of the countersignal, especially at variable speeds n and thus variable fundamental angular frequencies ω_G, a countersignal generation element is provided with a countersignal calculation element GS_RZ, which receives the variables in space vector representation and calculates the countersignal in space vector representation. This countersignal can then be combined as a signal shown in space vector representation, or added to a variable of the basic control loop, or can be transformed into a signal in the time domain in order to combine the time signal thus obtained with a variable of the basic control loop (also shown in the time domain).

The harmonic component (or the strength and angular position thereof) is determined. In the example shown, this is performed by a harmonic space vector transformation element RT_O. This receives the controlled variable in the form of the current I_EM as a signal in the time domain (in particular as individual phase currents I_U, I_V, I_W). The harmonic space vector transformation element RT_O receives a signal which reflects the controlled variable in the time domain, for example from a phase current measuring device SM. The controlled variable supplied to the transformation element RT_O is in this case the current output by the inverter INV (current of the inverter control output I_OUT) or the current in the electric machine EM.

As an alternative, shown in dashed lines, the harmonic space vector transformation element RT_O receives the controlled variable in the form of the power P_HV as a signal in the time domain. This variable corresponds to the alternating power of the current flowing at the supply input VE of the inverter INV and the relevant voltage (“ripple power”). The P_HV can be derived from the variables I_G_RZ and U_d, U_q. Since this power relates to the supply input of the inverter, this relationship is represented symbolically by a dashed line. The control device is preferably configured to minimize this AC power P_HV by means of the countersignal, preferably to 0.

The harmonic space vector transformation element RT_O receives a signal which reflects the controlled variable I_EM in the time domain, for example from a phase current measuring device SM; see the illustration in dashed lines. As an alternative (shown in dashed lines), the harmonic space vector transformation element RT_O receives a signal which represents the variable P_HV in the time domain, with this being derived approximately from the phase current measuring device SM. Preferably, however, by way of the reduction condition RBF, provision is made for a power P_HV resulting from space vector representations of I_G_RZ, U_d and U_q and approximately representing the power P_HV, the ripple power at the supply input VE to be minimized by the countersignal GS in space vector representation.

In order to detect in a simple way the harmonic component (as signal strength or space vector representation of the harmonic signal) of a certain frequency, namely the harmonic angular frequency ω_O, the harmonic detection element RT_O forms the controlled variable I_EM (present in time domain representation) on a space vector representation RZO which, however, is based on the harmonic angular frequency ω_O. In other words, the transformation of the time domain variables I_EM or I_U-I_W by means of a space vector transformation based on a rotation at the harmonic angular frequency ω_O generates a space vector representation of the harmonic component at the harmonic angular frequency. Since the corresponding space vector representation is based on this harmonic angular frequency ω_O, only rotating systems at this harmonic angular frequency are mapped, whereas rotating systems (in particular the rotating system of the basic control loop) or variables at the fundamental angular frequency are not mapped to a phasor at a rotationally constant amplitude. Using a space vector transformation based on the harmonic angular frequency automatically results in the representation of only the harmonic components which are already present in space vector representation. There are other possibilities for harmonic detection, for example low-pass or bandpass filtering, in which components at harmonic angular frequency ω_O are specifically allowed to pass through, or a spectral analysis (for the harmonic angular frequency ω_O) or a modulation at the harmonic angular frequency ω_O. With these other options, the controlled variable I_EM is processed in the time domain and the harmonic component is obtained in time domain representation. In particular, this time domain representation can then subsequently be transformed into a space vector representation (for the subsequent countersignal generation in space vector representation).

It is shown that an adapted harmonic angular frequency signal ω_O′ is supplied to the harmonic space vector transformation element RT_O. This results from the fundamental angular frequency ω_G (detected by the sensor SN in the example shown), with this signal being modulated by means of a harmonic modulator OM. In the example shown, the sixth harmonic is detected as a harmonic component. Since the countersignal generation is already based on a space vector representation which rotates at the fundamental angular frequency ω_G, care is taken when generating the adapted signal ω_O′ (two-part) that this fundamental rotation is taken into account. Therefore, for the representation of a concomitantly rotating harmonic system, modulation is effected using the factor +7, that is to say the order of the harmonic plus 1. To represent a counter-rotating harmonic rotating system, modulation is effected using a factor of −5 (=1−order of the harmonic). A harmonic modulator OM, which is shown in two parts, is used for the modulation for generating ω_O′. As mentioned, this takes into account the fact that the harmonic rotating system rotates relative to the fundamental rotating system (at six times the angular frequency), while the basic system, however, rotates at the fundamental angular frequency ω_G (relative to the stator).

The harmonic space vector transformation element RT_O is thus supplied with two harmonic angular frequency signals, which are represented together by ω_O'. One of the signals represents a concomitantly rotating system which rotates in the same direction as the rotating system of the basic control loop (only faster). This signal or signal component is used to extract a rotating system for the harmonic component which rotates in the same direction as the rotor or the basic rotating system. With the other component (shown as an example with the modulation factor −5), a rotating system which rotates in the opposite direction to the direction of rotation of the rotor or in the opposite direction to the rotating system of the basic control loop is extracted for the harmonic component. As mentioned, the ordinal number of the harmonic angular frequency (in the example 6) relates to the multiple of the fundamental angular frequency, so that the rotating system which is based on the harmonic angular frequency ω_O rotates relative to a system which rotates at the fundamental angular frequency, while the signal θ(t) of the sensor SN relates to the stator and thus the already existing basic rotation is taken into account by the factors deviating by +6 or −6 (+7 or −5).

The countersignal calculation element GS_RZ also works with variables in space vector representation and therefore a complex space vector representation of the harmonic I_O_RZ. Said countersignal calculation element comprises two components, namely a d and a q component, based on the harmonic with the reference sign I_d(O) and L_q(O). The space vector representation I_O_RZ is thus a d, q component representation, wherein, in the example shown, these represent the current (at the inverter control output I_OUT or in the electric machine EM) which can be attributed to the harmonic component. The space vector representation is a complex representation, with a real part and an imaginary part (I_d and I_q). Preferably, the complex space vector representation of the harmonic I_O_RZ which is received from the countersignal calculation element GS_RZ comprises both a space vector representation of a concomitantly rotating system which rotates in the same direction as the basic rotating system of the basic control loop and a representation of a rotating system rotating in the opposite direction. Both rotating systems rotate at the harmonic angular frequency relative to the basic system (which rotates at ω_G). Therefore, four individual signals can be received for the representation of the harmonic rotating system, that is to say an individual real part signal and an individual imaginary signal for the concomitantly rotating harmonic rotating system, and also an individual real part signal and an individual imaginary signal for the counter-rotating system, which rotates at ω_0.

The countersignal calculation GS_RZ includes a reduction condition RBF. This makes provision for the harmonic component (in space vector representation) within the controlled variable I_EM combined with the countersignal (as manipulated variable-also in space vector representation) to result in zero. This is represented symbolically by the formula I_d*U_d +I_q*U_q=0 (reduction condition) of the Figure. The reduction condition RBF makes provision, in particular, for the power P_HV (harmonic component at ω_G in current and voltage of the supply input VE) to be equal to 0. The above formula represents a simplified calculation of the harmonic power at the supply input VE, which is obtained from the variables I_d', I_q', U_d and U_q. A calculation device (not shown) which calculates P_HV from the latter variables may be provided. As P_HV relates to the supply input VE, a corresponding dashed symbol is shown, which represents the association of this variable with the supply input VE. In fact, P_HV can be calculated (approximately) from I_G_RZ, U_d and U_q.

The combination shown in the Figure is a power calculation for the harmonics of the controlled variable (as provided for in the electric machine EM) and the manipulated variable (of the controlled system RS). The procedure shown in the Figure is based on a d, q transformation (Park transformation), such that the relevant space vector representations are reproduced with d and q components. Furthermore, a selectable variable is obtained in the reduction condition: The components I_d and I_q of the reduction condition result from the harmonic detection RT_O, such that the components U_d and U_q together (which represent the countersignal which is indexed in the controlled system) can be selected for active attenuation in such a way that the harmonic component is reduced as desired. However, U_d, for example, can be freely selected, with U_q being calculated depending on inter alia U_d in order to meet the reduction condition. U_q can also be freely selected, with U_d being calculated depending on inter alia U_q in order to meet the reduction condition. This therefore results in a degree of freedom for the selection of U_d and U_q.

Therefore, a look-up table LT as data source can specify one of these two variables.

In the example shown, U_q(O) is specified (that is to say freely selected) so that U_d(O) can be calculated accordingly in the countersignal calculation element GS_RZ using the otherwise specified parameters I_d, I_q and U_q. Together, a countersignal GS which is based on the harmonic angular frequency ω_O in space vector representation is obtained. This is the output signal GS_ ω_O of the countersignal calculation element GS_RZ, with this signal being represented in space vector representation. The components of the space vector representation are two components, namely a real and an imaginary component, which together reproduce the complex space vector representation of the countersignal GS.

This is followed by an optional amplitude limitation element Lim, represented by a dashed rectangle. Upon infeed EGS of the countersignal GS, the harmonic component is actively attenuated in the basic control loop or in its manipulated variable guide element RS by combining the countersignal with the signal within the controlled system RS of the basic control loop. In particular, the countersignal GS is combined with the space vector representation of the manipulated variable U_d and U_q. The controlled variable RZG, in this case the pulse-width-modulated voltage, is present in the space vector representation RZG.

The countersignal output by the countersignal calculation element GS_RZ is present in a space vector representation based on a rotation at the harmonic angular frequency ω_O. In the controlled system RS of the basic control loop, however, the manipulated variable is present in a space vector representation RZG which is based on rotation at the fundamental angular frequency. In order to be able to combine these variables correctly in the infeed EGS of the countersignal GS, a modulator MOD is provided, which modulates the signal output by the countersignal calculation element GS_RZ (which is shown in space vector representation) at the harmonic angular frequency ω_O. In the illustrated example of the sixth harmonic, the countersignal (in space vector representation, based on ω_O as the rotational angular frequency) is thus modulated at six times the fundamental angular frequency ω_G, that is to say at ω_O. The result is an adapted countersignal GS_ω_G which is modulated at the harmonic angular frequency ω_O. This modulation is used to adapt the countersignal GS to the fundamental angular frequency which is the basis for the space vector representation of the manipulated variable in the controlled system RS of the basic loop. Starting from the rotor-fixed representation of the manipulated variable in the basic control loop (see controlled system RS), the rotating system of the space vector representation of the countersignal rotates faster, namely at the harmonic angular frequency, that is to say at the ratio of harmonic angular frequency and fundamental angular frequency. In the example shown, this is sixfold. To take this into account, therefore, the space vector representation of the harmonic signal (which relates to an imaginary rotation at ω_O) is modulated at the harmonic angular frequency so that, for the space vector representation RZG at fundamental angular frequency in the controlled system RS, the space vector representation of the countersignal rotates at six times the speed. Preferably, not only is a (concomitantly rotating or counter-rotating) rotating system which reproduces the countersignal GS generated, but preferably thus a concomitantly-rotating as well as a counter-rotating countersignal are generated in space vector representation. Both are then modulated, wherein, during modulation, the concomitantly rotating and the counter-rotating space vector representation of the countersignal are modulated while maintaining the direction of rotation, for example by modulation at the ratio of harmonic angular frequency and fundamental angular frequency and the negative expression thereof.

A symbolic reduction condition RBF is shown, which may correspond to the condition for P_VE illustrated above. The (unmodulated) variables U_dq(G) of the controlled system (reference frequency: fundamental) and the variable of the feedback element (I_d', I_q') as well as the harmonic signal I_d(O), L_q(O) are combined with one another to generate the countersignal GS. The reduction condition may include the previously mentioned approximation (with respect to P_VE).

In order to prevent the two-part controller REG of the basic control loop compensating for the countersignal by means of control, a subtraction element SUB is provided in a portion of the feedback element R or feedback section FB_G of the basic control loop. A modulated space vector representation of the harmonic component is fed in there. In the example shown, the subtraction element SUB is within a portion of the feedback section in which signals are transmitted in space vector representation; cf. signals I_d′ and I_q′. The signals correspond to a complex space vector representation of the controlled variable (which relates to the fundamental angular frequency ω_G). Since the signal into which the space vector representation of the countersignal is injected relates to a space vector representation which rotates at the fundamental angular frequency ω_G, the harmonic component is also modulated at the harmonic angular frequency or at the ratio of the harmonic angular frequency ω_O and the fundamental angular frequency ω_G (according to the order of the harmonic). The harmonic component is thereby subtracted from the feedback R, such that the deviation detection element detects the harmonic components in at least partially reduced form. Since the control deviation forms the input variable for the two-part controller REG, this controller will not react to the harmonic components, since, as mentioned above, the subtraction from the feedback R of the basic control loop has already been removed in advance.

A low-pass filter TP or an average value generator (in particular for the formation of a moving average value) may be provided, through which the space vector representation of the harmonic component RZO is guided. This low-pass filter TP or average value generator may be connected downstream of the harmonic detection element RT_O or may be connected upstream of the countersignal calculation element GS_RZ. In particular, the low-pass filter TP suppresses AC components in the space vector representation of RZO, which result from signals with an angular velocity other than the desired harmonic angular velocity. Such signals outside the desired harmonic angular velocity are mapped in a space vector transformation at the desired harmonic angular velocity into AC components which are compensated in particular by rotation to zero.

Since both the harmonic is detected and the countersignal is calculated for countersignal generation, both components can be referred to as countersignal generation element. The Figure shows an embodiment in which the harmonic detection is carried out by means of harmonic space vector transformation, which transforms power signals I_EM into a space vector representation RZO. However, other ways to calculate the harmonic strength can also be used.

The controlled variable I_EM comprising the signals I_U to I_W, that is to say the currents which are used to operate the electric machine, can be referred to as power signal or power signals. In this case, it is a controlled variable which results from the operation of the electric machine EM using the pulse-width-modulated voltage/power signal (manipulated variable, time domain representation) and is output at the output I_OUT of the inverter INV or flows in the electric machine. In other words, the electric machine EM converts the pulse-width-modulated signals output by the inverter into a controlled variable. The currents I_U to I_W flow due to the pulse-width-modulated voltage. Since these currents form the controlled variable and the target variable generation SE also relies on currents as power signals (target values), the deviation detection RA or its control deviation signal is based on the difference between the actual currents of the electric machine (in space vector representation) and the target input variable I_d, I_q, which is input as the target value in space vector representation REF_RZ into the deviation detection element RA.

The basic control loop has a manipulated variable guide element RS in which the variables are processed and transmitted in space vector transformation. This may also be referred to as a manipulated variable section. At the end of this section, there is an inverse space vector transformation IRT, which inputs pulse-width-modulated voltage drive signals PWM_U-PWM_W as pulse-width signal into the inverter input I_IN. This section between the inverse space vector transformation IRT and the control input I_IN of the inverter is a portion of the entire manipulated variable guide element of the basic control loop. In this portion, the signals are guided in time domain representation.

An alternative embodiment makes provision for the countersignal GS to also be able to be fed in as a time-domain signal at the location marked by EGS', which is located downstream of the inverse space vector transformation IRT (that is to say a location in the entire controlled variable section of the basic control loop which follows the illustrated space vector-guiding controlled variable section RS. This would require a less computationally intensive transformation of the space vector representation of the countersignal GS into time-domain signals. Here, for example, the unit which carries out the pulse width modulation (for example IRT) may have an input for a countersignal in the time domain in order to modulate in the generation of the pulse-width signal PS not only according to the manipulated variable, but also according to the countersignal. There are optionally two modulation portions, where one modulation portion carries out the pulse width modulation for setting the manipulated variable and the other modulation reproduces the countersignal in pulse width modulation. Both modulated signals are then combined and transmitted to the control input I_IN of the inverter INV.

In summary, it can be seen that the countersignal generation GS_RZ works with a representation of the harmonic components in space vector transformation, which results in a simplified calculation. This results, in particular, from the fact that the space vector transformation already starts from a rotating system and thus the reproduction of the relevant components can be carried out using non-rotating parameters. Therefore, the compensation of the harmonic components by feeding in the countersignal in space vector transformation is greatly simplified and only has to follow changing basic operating parameters of the electric machine, for example the speed, but not with the rotation angle of the rotor, which rotates at the fundamental angular frequency. This applies to synchronous motors; in the case of asynchronous motors, rotation relates to the rotation of the stator field, wherein, in addition to the current, the speed of the asynchronous machine can also be used as controlled variable. The space vector representation of the countersignal, which is based on a rotation of the space vector representation at the harmonic angular frequency ω_O, is adjusted by modulation at the harmonic angular frequency ω_O, such that with a space vector representation based on the fundamental angular frequency, for said signal based on the fundamental angular frequency, the countersignal rotates at the harmonic angular frequency.

### LIST OF REFERENCE SIGNS

GS: Countersignal
GSS: Signal strength of the countersignal
R: Feedback
FB_O: Countersignal feedback
EC: Input variables, target value input
RA: Control deviation, deviation detection element
RS: Manipulated variable guide element
REG: Linear controller
GSE: Countersignal infeed element
EG_T: Transformation of the input variable into a space vector representation
Additional _RZ: Space vector representation
PS: Pulse-width signal
MA: Modulation output
RZG: Space vector variables (interference-suppressed)
IRT: Inverse space vector transformation
RT_O: Harmonic space vector transformation/harmonic detection element
INV: Inverter
I_IN: Inverter control input
I_OUT: Inverter control output
I_EM: Output signal of the inverter
SN: Sensor
Θ: Rotor angle, θ(t): Time signal of the rotor angle
ω_G: Fundamental angular frequency
ω_O: Harmonic angular frequency
OM: Harmonic modulator
TP: Low-pass filter
L_d(O), L_q(O): Complex d, q components of the harmonic
I_O_RZ: Complex space vector representation of the harmonic
EGS: Infeed element of the countersignal (GS)
Lim: Limiter
GS_RZ: Countersignal calculation in space vector representation
MOD, MOD′: Modulator
RT: Transformation into a space vector representation
SM: Current measuring device (for detecting the operating currents of the EM) VE: Supply input (voltage supply input) of the inverter
P_HV: Harmonic power at the supply input VE
I_HV, U_HV: Current and voltage at the supply input VE

The components described functionally here are preferably in the form of device elements.

1. A control device for controlling an electric drive having an inverter and a multiphase electric machine, wherein the control device has a basic control loop which comprises:
a target value input,
a subsequent deviation detection element,
a manipulated variable guide element which is connected downstream of the deviation detection element and has a modulation output which is connected to the inverter for drive purposes and
a feedback section wherein
the basic control loop for vector control is formed with a manipulated variable in space vector representation, which relates to a fundamental angular frequency, wherein the control device furthermore comprises
a countersignal feedback element, via which an inverter control output of the inverter connected to an infeed element of a countersignal, wherein the countersignal feedback element comprises
a countersignal generation element which is connected downstream of the inverter control output, an inverter control input and/or a supply input of the inverter and to which at least one power signal of the drive is applied in the time domain, and wherein the countersignal generation element is configured to calculate and output a space vector representation of the countersignal in relation to the harmonic angular frequency.

2. The control device as claimed in claim 1, wherein the infeed element is connected downstream of the countersignal generation element, is provided in a portion of the manipulated variable guide element of the basic control loop in which the manipulated variable is transmitted as the space vector representation and is configured to combine the space vector representation of the countersignal with the space vector representation of the manipulated variable and to forward the combined space vector representation, in which a harmonic component at harmonic angular frequency is reduced by the countersignal, in the manipulated variable guide element as manipulated variable or wherein
the infeed element is connected downstream of the countersignal generation element, is provided in a portion of the manipulated variable guide element of the basic control loop in which the manipulated variable is transmitted as a pulse-width-modulated time domain signal and is configured to combine a time domain representation of the countersignal with the pulse-width-modulated time domain signal and to forward the combined pulse-width-modulated time domain signal, in which a harmonic component at harmonic angular frequency is reduced by the countersignal in the manipulated variable guide element as manipulated variable.

3. The control device as claim 1, wherein a modulator is connected between the countersignal generation element and the infeed element, which modulator is configured to modulate the space vector representation or time domain representation of the countersignal calculated by the countersignal generation element at the harmonic angular frequency in order to output the thus modulated space vector representation or time domain representation of the countersignal to the infeed element.

4. The control device as claimed in 1, wherein the countersignal generation element has a harmonic detection element having an input which
is connected to an inverter control output to which at least one power signal of the electric machine is applied in the time domain or in space vector representation, wherein the harmonic detection element is configured to detect the harmonic component in the at least one power signal and has an output at which the harmonic component is output in harmonic space vector representation;
is connected to the manipulated variable guide element and/or the feedback section to which the manipulated variable of the manipulated variable guide element or the controlled variable of the feedback section is present in space vector representation, wherein the countersignal generation element is configured to determine the harmonic component from the manipulated variable and/or from the controlled variable; and/or
is connected to a supply input of the inverter to which a power signal of the inverter or the AC components thereof is or are applied in the time domain, wherein the harmonic detection element is configured to detect the harmonic component in the at least one power signal of the inverter and has an output at which the harmonic component is output in harmonic space vector representation.

5. The control device as claimed in claim 4, wherein the at least one power signal is present in the time domain and the harmonic detection element is designed as a harmonic space vector transformation element which transforms the power signal into a space vector representation which rotates at the harmonic angular frequency relative to the space vector representation of the manipulated variable; or
is designed as a high-pass filter or bandpass filter which blocks the fundamental angular frequency and allows the harmonic angular frequency to pass through, or is designed as a spectral analysis device which extracts, as a spectrum, components of the harmonic angular frequency together with the phase of these components.

6. The control device as claimed in claim 1, wherein the countersignal generation element has a countersignal calculation element having an input which is configured to receive the harmonic component which is present in the power signal, in space vector representation and, in particular, to receive a controlled variable, which is fed from the inverter control output of the inverter into the feedback section, in space vector representation and is further configured to map the space vector representation of the harmonic component, in particular in combination with the controlled variable, using a reduction condition on the space vector representation of the countersignal, preferably taking into account an angular relationship between the manipulated variable and a representation of the power signal of the drive.

7. The control device as claimed in claim 6, wherein the space vector representation of the countersignal is reproduced with values on two mutually angularly fixed, rotating axes, and the countersignal calculation element is configured to map a value of one of the axes from the countersignal calculation element according to the reduction condition, while a value source, such as a lookup table, is provided to specify the associated value of the other axis and the countersignal calculation element has an input to which the value source is connected so as to output signals and the countersignal calculation element is configured to map the space vector representation of the harmonic component to the space vector representation of the countersignal taking into account the associated value.

8. The control device as claimed in claim 1, wherein a subtraction element is provided in the feedback section of the basic control loop, which subtraction element is configured to subtract the harmonic component from a controlled variable which is fed from the inverter control output of the inverter into the feedback section, and to transmit the resulting signal in the feedback section.

9. The control device as claimed in claim 8, wherein the subtraction element is provided in a portion of the feedback section of the basic control loop in which signals are transmitted in space vector representation and the harmonic component in space vector representation is subtracted in the subtraction element based on the harmonic angular frequency.

10. The control device as claimed in claim 1, wherein the countersignal generation element has a countersignal calculation element which has an input which is configured:
to receive a controlled variable which is provided in space vector representation and which is output by the inverter control output, and
to receive a manipulated variable of the manipulated variable guide element provided in space vector representation,
wherein the space vector representations of the controlled variable and the manipulated variable relate to the fundamental angular frequency.

11. The control device as claimed in claim 1, wherein a two-part linear controller is provided between the deviation detection element and the subsequent infeed element of the countersignal, which linear controller comprises a first and a second controller part, wherein the first controller part-relates to a first axis of the space vector representation and the second controller part relates to a second axis of the space vector representation.

12. The control device as claimed in claim 2, wherein a modulator is connected between the countersignal generation element and the infeed element, which modulator is configured to modulate the space vector representation or time domain representation of the countersignal calculated by the countersignal generation element at the harmonic angular frequency in order to output the thus modulated space vector representation or time domain representation of the countersignal to the infeed element.
